(19) United States
(12) Patent Application Publication
(10) Pub. No.: US 2001/0044153 A1
(43) Pub. Date: Nov. 22, 2001

(54) Automatic liquid analyser and quality controller

(76) Inventors: Dominique Gagnon, Beauport (CA); Michel St-Hilaire, Loretteville (CA)

Correspondence Address: SWABEY OGILVY RENAULT, SUITE 1600, 1981 MCGILL COLLEGE AVENUE, MONTREAL, QC, H3A2Y3, CA

(21) Appl. No.: 09/858,447

(22) Filed: May 17, 2001

(30) Foreign Application Priority Data
May 18, 2000 (CA) 2307978

(51) Int. Cl. G01N 21/78

(52) U.S. Cl. 436/125; 422/82.05; 436/164

(57) ABSTRACT

A method and apparatus for automatically calculating and controlling levels of a given chemical in a liquid from a liquid reservoir using colorimetry testing, the method comprising the steps of (i) collecting in an optical chamber a sample of liquid from a liquid reservoir; (ii) taking a calibration colorimetry A reading of the liquid sample, whereby a reference voltage value B representative of an acceptable limit of a known chemical is calculated and stored in a memory of a controller unit; (iii) releasing the liquid sample from the optical chamber; (iv) collecting in the optical chamber a further sample of liquid from the liquid reservoir; (v) adding a predetermined quantity of a reagent to the further sample in the optical chamber, the reagent chosen as having properties making it react to the presence of the known chemical present or to be added to the liquid; (vi) taking a test colorimetry reading C of the further sample with the reagent added thereto and obtaining a voltage signal representative thereof, whereby a level of the known chemical is known with respect to the reference voltage value B; and (vii) adding a calculated quantity of the known chemical to the liquid reservoir in response to the calculated level of the known chemical in the further sample if the calculated level is below the reference voltage value B.

### FIELD OF THE INVENTION

The present invention relates to an automatic liquid analyser and quality controller and more particularly, but not exclusively, for use with swimming pools, spas and other reservoirs wherein a chemical admixed with a liquid requires to be monitored and maintained in predetermined quantity within the liquid.

### BACKGROUND OF THE INVENTION

Water basins and reservoirs are commonly found in the commercial and leisure industries under various forms, such as swimming pools, fish farming ponds, etc. maintaining a specific water quality is essential in many leisure or industrial applications. For instance, a water quality standard provides comfort and safety to swimmers using a swimming pool.

Accordingly, water reservoirs often require periodic monitoring and chemical treatment in order to attain regulated quality levels. For example, it is a known practice to add a halogen such as chlorine to the water of a swimming pool to achieve an effective sterilization thereof. Many methods have thus been provided in order to quantify the level of chemicals in the water. One such method is referred to as colorimetry and consists of injecting a reagent in a sample of water which changes color in reaction to a given chemical (i.e. chlorine in the case of a swimming pool). This level of chemical may be interpreted from the intensity of light from a light source passing through the reagent/water mixture.

One of the advantages of the colorimetry method resides in the fact that it is very simple and inexpensive to achieve. Canadian Patent No. 2,169,248, issued on Oct. 10, 1997 to Privé discloses an automatic chemical monitor and control system to be used mainly with swimming pools. This patent describes the use of colorimetry with samples of water extracted from the recirculating water line of a swimming pool in order to determine the level of treatment chemical and pH thereof. The system also injects chemicals in the water recirculation line in response to the variance between the calculated level of chemicals and a predetermined reference value.

The above described patent provides a fully automated system which monitors the water quality and reacts to adjust the quality if it differs from predetermined quality values. However, the system of the above described patent involves costly and lengthy adaptation in order to provide a new or an existing pool therewith, as it must be connected to the recirculating water line. It is also pointed out that the system of the above described patent has a predetermined reference value, and thus no autocalibration of this system is achieved.

U.S. Pat. No. 6,113,858, issued on Sep. 5, 2000 to Tang et al. discloses a monitor for continuous concentration measurements of liquid samples which uses colorimetry testing therefor. The monitor comprises a cavity at a bottom thereof being open to the liquid reservoir whose liquid is to be analysed. A light emitter and a light detector are face to face on opposed walls of the cavity, whereby concentration of a chemical in the liquid may be determined by sensing the intensity of a light signal passing therethrough when a reagent has been added to the sample. The reagent, stored in the monitor, is injected in the sample. However, the cavity is open whereby the accuracy of the signal is questioned. Furthermore, no calibration is involved and the cavity is also subject to daylight as it is open to the reservoir.

### SUMMARY OF THE INVENTION

It is a feature of the present invention to provide an automatic liquid analyser and quality controller which substantially overcomes the drawbacks of the prior art.

It is a further feature of the present invention to provide an automatic liquid analyser and quality controller having a rinsing cycle for ensuring proper reading conditions of colorimetry equipment.

It is still a further feature of the present invention to provide a method for automatically analyzing water and for automatically controlling its quality which substantially overcomes the drawbacks of the prior art,

According to the above features, from a broad aspect, the present invention provides a method for automatically calculating levels of a given chemical in a liquid from a liquid reservoir using colorimetry testing, comprising the steps of (i) collecting in an optical chamber a sample of liquid from a liquid reservoir; (ii) taking a calibration colorimetry reading of the liquid sample, whereby a reference voltage value representative of an acceptable limit of a known chemical is calculated and stored in a memory of a controller unit; (iii) releasing the liquid sample from the optical chamber; (iv) collecting in the optical chamber a further sample of liquid from the liquid reservoir, (v) adding a predetermined quantity of a reagent to the further sample in the chamber, the reagent chosen as having properties making it react to the presence of the known chemical present or to be added to the liquid; and (vi) taking a test colorimetry reading of the further sample with the reagent added thereto and obtaining a voltage signal representative thereof, whereby a level of the known chemical in the liquid is known with respect to the reference voltage value.

According to a further broad aspect of the present invention, there is provided an automatic liquid analyser for calculating levels of a given chemical in a liquid from a liquid reservoir using colorimetry testing, the automatic liquid analyser comprising an optical chamber for receiving liquid samples therein. The optical chamber is connected to a liquid reservoir by a liquid inlet line, and is connected to a drain by a sample outlet line. A pump is mounted on the liquid inlet line and is adapted for conveying samples of liquid from the liquid reservoir to the optical chamber. A valve is mounted on the sample outlet line for opening and closing same so as to release and retain liquid in the optical chamber. A first reagent reservoir stores a reagent. A reagent line extends between the reagent reservoir and the optical chamber. A second pump is mounted on the reagent line and is adapted for conveying predetermined quantities of the reagent from the reagent reservoir to the optical chamber. A light source is mounted to the optical chamber for emitting a light signal for colorimetry testing. A light detector is mounted to the optical chamber opposite the light source and aligned therewith for receiving the light signal for colorimetry testing. A controller unit calculates the level of a known chemical according to intensity of the light signal detected and for controlling the automatic liquid analyser according to the above described method.

According to a still further broad aspect of the present invention, there is provided a method for automatically calculating and controlling levels of a given chemical in a liquid from a liquid reservoir using colorimetry testing, the method comprising the steps of (i) collecting in an optical chamber a sample of liquid from a liquid reservoir; (ii) taking a calibration colorimetry reading of the liquid sample, whereby a reference voltage value representative of an acceptable limit of a known chemical is calculated and stored in a memory of a controller unit; (iii) releasing the liquid sample from the optical chamber; (iv) collecting in the optical chanter a further sample of liquid from the liquid reservoir; (v) adding a predetermined quantity of a reagent to the further sample in the optical chamber, the reagent chosen as having properties making it react to the presence of the known chemical present or to be added to the liquid; (vi) taking a test colorimetry reading of the further sample with the reagent added thereto and obtaining a voltage signal representative thereof, whereby a level of the known chemical is calculated with respect to the reference voltage value; and (vii) adding a calculated quantity of the known chemical to the liquid reservoir in response to the calculated level of the known chemical in the further sample if the calculated level is below the reference voltage value.

According to a still further broad aspect of the present invention, there is provided an automatic liquid analyser and quality controller for controlling levels of a given chemical in a liquid from a liquid reservoir using colorimetry testing. The automatic liquid analyser and quality controller comprises an optical chamber for receiving liquid samples therein. The optical chamber is connected to a liquid reservoir by a liquid inlet line, and is connected to a drain by a sample outlet line. A first pump is mounted on the liquid inlet line and is adapted for conveying samples of liquid from the liquid reservoir to the optical chamber. A valve is mounted on the sample outlet line for opening and closing same so as to release and retain liquid in the optical chamber. A first reagent reservoir stores a reagent. A reagent line extends between the reagent reservoir and the optical chamber. A second pump is mounted on the reagent line and is adapted for conveying predetermined quantities of the reagent from the reagent reservoir to the optical chamber. A light source is mounted to the optical chamber for emitting a light signal for colorimetry testing. A light detector is mounted to the optical chamber opposite the light source and aligned therewith for receiving the light signal for colorimetry testing. A chemical reservoir stores an amount of a known chemical. The chemical reservoir is adapted to be mounted to a portion of the liquid reservoir, and has conveying means extending therefrom to the portion of the liquid reservoir and is actuated by a motor for adding calculated quantities of the known chemical to the liquid reservoir. A controller unit calculates the level of the known chemical according to intensity of the light signal detected and controls the automatic liquid analyser and quality controller according to the above described method.

### BRIEF DESCRIPTION OF THE DRAWINGS

A preferred embodiment of the present invention will now be described in detail having reference to the accompanying drawings in which:

FIG. 1 is a schematic diagram of the automatic liquid analyser and quality controller of the present invention;

FIG. 2 is a flow chart illustrating the operation of a controller unit of the present invention;

FIG. 3 is a flow chart illustrating further steps of operation of the controller unit; and

FIG. 4 is a side elevational view of an automatic chemical dispenser constructed in accordance with the present invention.

### DESCRIPTION OF PREFERRED EMBODIMENTS

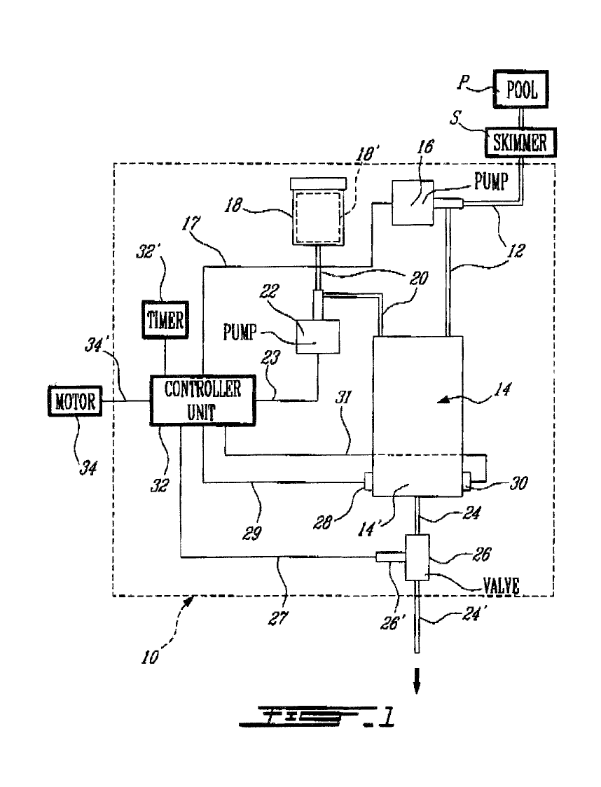

Referring to the drawings and, more particularly, to FIG. 1, an automatic liquid analyser and quality controller of the present invention is generally shown at 10. The automatic liquid analyser and quality controller 10 is connected to a liquid reservoir such as a swimming pool P provided with a typical skimmer S by a liquid inlet line 12. The automatic liquid analyser and quality controller 10 has an optical chamber 14 which is connected to the skimmer S by the liquid inlet line 12. A pump 16 ensures the flow of water from the skimmer S to the optical chamber 14 through the liquid inlet line 12. The automatic liquid analyser and quality controller 10 also has a reagent reservoir 18 which is connected to the optical chamber 14 through a reagent line 20. A pump 22 ensures the flow of reagent from the reagent reservoir 18 to the optical chamber 14 through the reagent line 20. The reagent has a property by which it changes the color of a liquid sample in the presence of a chemical in the liquid sample. For instance, orthotolidine reacts to the presence of chlorine in a water sample. Also, further reagent reservoirs may be provided with the automatic liquid analyser and quality controller 10 to control other criteria of a liquid sample with the same automatic liquid analyser and quality controller 10. For instance, pH may also be monitored by the automatic liquid analyser and quality controller 10. It is pointed out that mechanisms equivalent to pumps (i.e. in reference to pumps 16 and 22) may be provided in order to achieve the conveying of liquid samples to the optical chamber 14 (e.g. motor with an endless screw, gravity feeding valve, etc.). The reagent reservoir 18 is provided with an internal or external detector (not shown) to signal to the controller unit 32 when the reservoir 11 is close to being emptied. The controller unit 32 will activate a visible or audible alarm to indicate the reagent needs to be added.

A solution outlet line 24 is connected to a bottom wall of the optical chamber 14 to provide an outlet for liquid captured in the optical chamber 14. The flow of liquid through the solution outlet line 24 is controlled by a valve 26 connected thereto. When the valve 26 is in an open position, the liquid in the solution outlet line 24 is drained through line 24′. When the valve is in a closed position, liquid is captive in the optical chamber 14. It is pointed out that the valve 26 is a 2-way solenoid valve or the like.

A light source 28 and a light detector 30 (e.g. a photocell, etc.) are secured to side walls 14′ of the optical chamber 14 so as to be positioned opposite and in alignment with one another. Consequently, light emitted from the light source 28 (e.g. white or colored light) is sensed by the light detector 30. It is pointed out that the side walls 14′ of the optical chamber 14 are preferably opaque, whereby the interior of the optical chamber 14 is isolated from external light, such that the only light emerging in the optical chamber 14 and sensed by the light detector 30 is emitted by the light source 28.

The automatic liquid analyser and quality controller 10 also comprises a controller unit 32. As shown in FIG. 1, the controller unit 32 is wired to pumps 16 and 22 by the connector lines 17 and 23, respectively. It is also connected to a port 26′ of the valve 26 by connector line 27. The light source 28 is connected to the controller unit 32 by the connection cable 29. The light detector 30 feeds signals to the controller unit 32 by its cable connection 31. The controller unit 32 has an integrated control circuit incorporating an IC chip. It also controls a motor 34 through its connection 34′. The controller unit 32 may comprise elements such as an analogue to digital converter, a counter, an alarm, a display screen and a timer 32′. This will be described in further detail hereinafter.

The controller unit 32 is programed to control the operation of the automatic liquid analyser and quality controller 10. The controller unit 32 controls the pump 16 to admit water from the skimmer S of the pool P in the optical chamber 14. It also controls the valve 26 between its open and closed positions. Consequently, by closing the valve 26, and by activating the pump 16, the optical chamber 14 may be filled with water from the skimmer S through the liquid inlet line 12. It is pointed out that the optical chamber 14 may be provided with vent holes having check valves (not shown) at a top thereof in order to expel air for the water to fill the optical chamber 14 when the valve 26 is closed. The pump 16 is also actuated by the controller unit 32 when the valve 26 is opened so as to rinse the optical chamber 14 after it has been evacuated of its contents, and the rinse water injected by the pump 16 will exit through the solution outlet line 24 to the drain.

The controller unit 32 also controls the pump 22 to inject reagent 18, from the reagent reservoir 18 into the optical chamber 14, through the reagent line 20. The amount of reagent 18′ is controlled by the operating drive of the pump 22 to dispense a predetermined quantity of drops of reagent 18′. Consequently, predetermined quantities of water from the skimmer S and reagent 18′ from the reagent reservoir 18 are injected in the optical chamber 14, whereby colorimetry testing may be achieved.

Accordingly, the controller unit 32 may quantify the level of coloration of the mixture in the optical chamber 14 by emitting light from the light source 28 and quantitatively sensing the signals from the light detector 30. In response thereto, if, for instance, the chlorine level of the water sample is too low, the motor 34 may be actuated by the controller unit 32 whereby chlorine may be released in the skimmer S to raise the calculated low value.

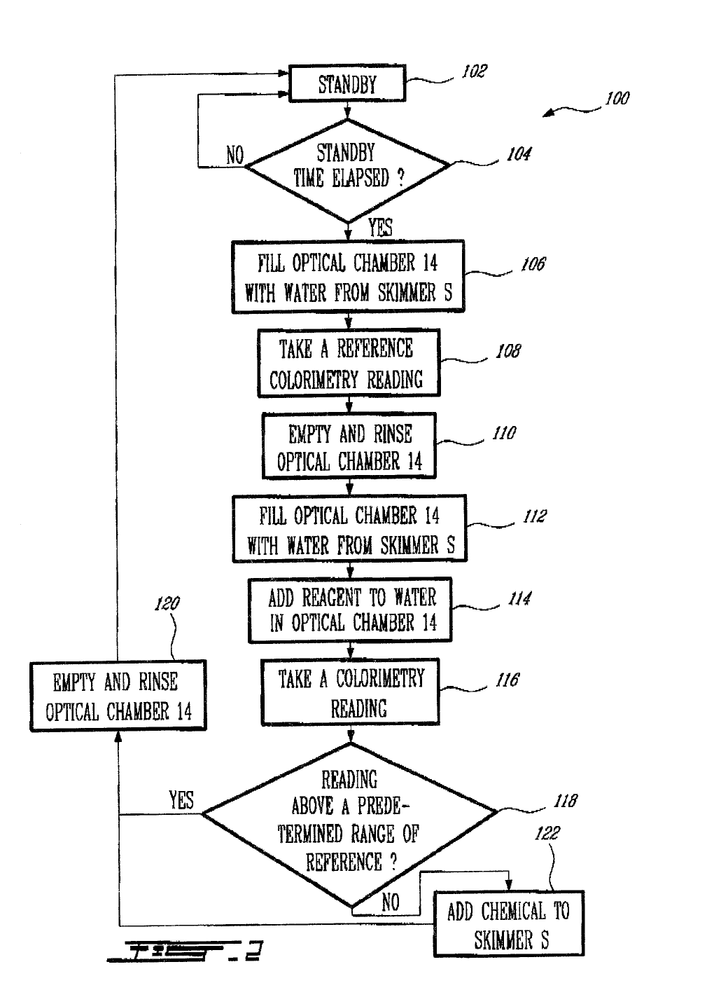

Referring now to FIG. 2, the steps of operation of the controller unit 32 are generally shown at 100. According to step 102, the controller unit 32 is in a standby state, whereby a period of time is determined for the controller unit 32 (e.g. programmable/presetable by an operator/user) to be in a standby state and is held by the timer 32′. If the automatic liquid analyser and quality controller 10 is wired for a first use, the standby period (i.e. set time delay) is at zero.

According to step 104, if the standby time is elapsed, the controller unit 32 will go to step 106. Otherwise, the controller unit 32 will remain in standby until the set time delay has elapsed.

According to step 106, the optical chamber 14 is filled with water from the skimmer S. This is achieved by valve 26 being closed by the controller unit 32 and the pump 16 being actuated. The controller unit 32 may be programmed in order to operate the pump 16 during step 106 such that the optical chamber 14 is filled up to a predetermined level, whereby a predetermined volume of water is in the optical chamber 14.

According to step 108, a colorimetry reference reading is taken by the controller unit 32. This is achieved by the controller unit 32 actuating the light source 28 to emit light through the liquid in the optical chamber 14. The light will be sensed by the light detector 30. It is pointed out that the controller unit 32 is provided with the necessary circuitry in order to interpret the detected light signals. For instance, the controller unit 32 may comprise an analogue to digital converter (not shown) in order to convert the analogue voltage value to a digital value to treat the signals.

The colorimetry reference reading taken at step 108 (i.e. in the form of a voltage signal) is stored as a digital signal value by the controller unit 32. The step 108 ensures the self-calibration of the automatic liquid analyser and quality controller 10. This is due to the fact that a water sample having a reagent added thereto will remain clear if it has little or no chemical such as chlorine therein. By taking a reading of a water sample to which no reagent has been added, this sample will surely be clear and thus, will provide an output signal equivalent to a water sample to which reagent has been added but without any chemical therein and thus not reacting to the reagent, A differential voltage value (B-A) between a colorimetry reading A of a sample without chemical (and thus not reacting) and a colorimetry reading B of a sample having chemical at the limit of the level of acceptability according to given standards is known and programmed in the controller unit 32. Thus, the reference colorimetry reading taken at step 108 is equivalent to the colorimetry reading A, whereby B can be calculated. Finally, it is pointed out that when undergoing the step 108 in a subsequent liquid sample analysis, the reference value stored will be replaced by the reference value of the subsequent reference reading,

According to step 110, the optical chamber 14 is emptied of the water sample and is rinsed. This is achieved by the controller unit 32 opening valve 26 in order to release the water sample from the optical chamber 14 to the drain. Thereafter, the pump 16 is actuated to rinse the optical chamber 14 with water from the skimmer S. This rinsing water does not accumulate in the optical chamber 14 as the valve 26 remains open throughout the rinsing process and it is evacuated to the drain.

According to step 112, the optical chamber 14 is again filled with a water sample from the skimmer S. This step is similar to step 106.

According to step 114, reagent is added to the water sample in the optical chamber 14. This is achieved by the controller unit 32 actuating the pump 22 in order to extract a predetermined quantity of reagent from the reagent reservoir 18 to inject it in the optical chamber 14 through the reagent line 20. The pump 22 is chosen in order to control with precision the quantity of reagent it injects in the optical chamber 14. The reagent is chosen to react to a specific chemical in the water by changing color. For instance, orthotolidine reagent may be used to react to chlorine, as previously mentioned.

According to step 116, a colorimetry reading C is taken by the controller unit 32, and this time with reagent added to the water sample, as mentioned in step 114. Similarly to step 108, the controller unit 32 controls the emission of a light signal by the light source 28 and the detected light passing through the reagent/water solution in the optical chamber 14 to the light detector 30 generates a signal which is quantitatively interpreted by the controller unit 32. The light signal is preferably of with color and of a wave length compatible with the light detector 30.

According to step 118, the colorimetry reading C taken at step 116 is compared to the value B calculated by the reference colorimetry reading A taken at step 108 and which has been stored in the memory of the IC chip of the controller unit 32. If the colorimetry reading C of step 116 is above the value B calculated from the reference colorimetry reading A of step 108, the controller unit 32 will go to step 120, wherein the optical chamber 14 is emptied and rinsed, in a similar fashion to step 110. Thereafter, the controller unit 32 will be put on standby according to a preset timer value. If the colorimetry reading is below the value B calculated from the reference colorimetry reading A of step 101, the controller unit 32 will reach step 122, wherein chemical (e.g. chlorine or bromine, etc.) is added to the skinner S. This is achieved by the controller unit 32 actuating the motor 34, as shown in FIG. 1. Thereafter, the controller unit 32 will go to the step 120, previously described, which consists in emptying and rinsing the optical chamber 14.

It is pointed out that FIG. 2 may also have its step 122 of adding chemical to the skimmer S removed therefrom in the event where a display screen is provided with the controller unit 32. In this case, an operator can manually insert chemical to the liquid reservoir according to the displayed value. Furthermore, if the reading comparison of step 118 is outside the predetermined range, an alarm, whether it be visual or sound, may be actuated in order to inform the operator.

The flow chart of FIG. 2, as described above, discloses simple steps of operation of the present invention. However, is has been thought to provide the controller unit 32 with an alarm system which will intervene if too many colorimetry readings 116 showing low levels of the given chemical are taken successively.

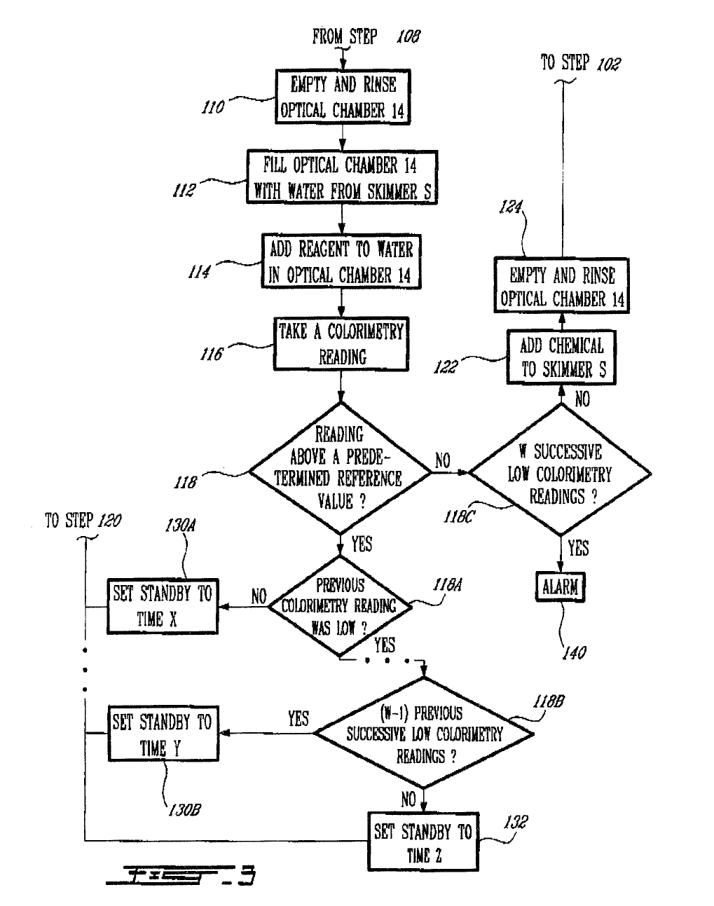

Referring now to FIG. 3, a flow chart is shown illustrating the steps achieved by the controller unit 32 in another embodiment of the present invention. For clarity purposes, steps 102, 104, 106 and 108 have been removed from FIG. 3 as they represent the same steps as in FIG. 2.

According to stop 110, the optical chamber 14 is emptied and rinsed from the water sample used for the reference colorimetry reading A of step 108.

According to step 112, the optical chamber 14 is tilled with water from the skimmer S. This is similar to step 112 of FIG. 2.

According to step 114, reagent is added to the water in the optical chamber 14. This is similar to step 114 of FIG. 2,

According to step 116, a colorimetry reading C is taken by the controller unit 32. This is similar to step 116 of FIG. 2.

According to step 118, the colorimetry reading C of step 116 is compared to the value B calculated from the reference colorimetry reading A of step 108. If the reading C is above the value B calculated from the reference colorimetry reading A taken at step 108, the controller unit 32 will go to step 118A. If the colorimetry reading C of step 116 is below the value B calculated from the reference colorimetry reading A of step 108, the controller unit 32 will go to step 118C.

According to step 118A, if the previous colorimetry reading C taken was low, the controller unit 32 will go to step 130A. This involves that the controller unit 32 comprises a counter which accounts series of successively low colorimetry readings C taken at step 116. In doing so, the controller unit 32 ensures that an operator is alarmed (as will be explairned hereinafter) if, upon a few successive additions of chemical to the skimmer S, the chemical is still not detected, in which case there may be a problem with the automatic liquid analyser and quality controller 10. It is pointed out that this requires that the counter is reset for each positive colorimetry reading taken at 116, which will thus reach step 118A. Therefore, the step 120 of emptying and rinsing the optical chamber 14 may involve having the controller unit 32 resetting the counter to zero. As shown in FIG. 3, steps 118A and 118B are shown and step 118B requires that W-1 colorimetry readings C are compared.

This allows for a programmer of the controller unit 32 to set an alarm step according to the number of colorimetry readings C taken. For instance, if more than one colorimetry reading taken at 116 are successively low, it may be required that the standby time be shortened. Therefore, steps 130A and 130B show that standby time of the controller unit 32 may be adjusted in accordance with the number of colorimetry readings taken. Ultimately, if too many colorimetry readings are successively low (e.g. W low successive readings), an alarm may be actuated. This is achieved by providing 118C which interprets the number of successively low colorimetry readings taken when the controller unit 32 requires that chemical is added to the skinner S, which is shown at step 122. In FIG. 3, it is illustrated that if the number of colorimetry readings taken is of W, the alarm 140 will be actuated.

According to step 124, the optical chamber 14 is emptied and rinsed.

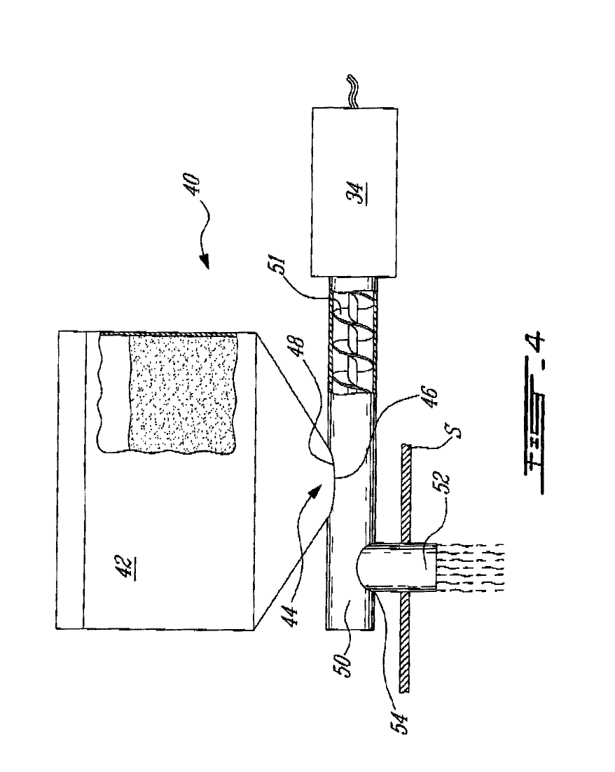

Referring now to FIG. 4, an automatic chemical reservoir is generally shown at 40. The chemical reservoir 40 comprises the motor 34 which, as described above, is connected to the controller unit 32. The chemical reservoir 40 further comprises a reservoir 42 having a constricted bottom portion 44 and an opening 46 at a bottom thereof. The opening 46 of the reservoir 42 is disposed opposite an opening 48 of a cylinder 50 to release the chemical therein. An endless screw 51 is axially disposed in the cylinder 50 and is actuated by the motor 34. The cylinder 50 is open to the skimmer S by conduit 52 which is connected to the opening 54 downstream of the reservoir 42. Therefore, a chemical in the chemical reservoir 40 is processed through the cylinder 50 by the endless screw. The chemicals reach the conduit 52 to fall in the skimmer S. The reservoir 42 is also provided with an internal or external mechanical detector (not shown) to signal the controller unit 32 that chemical needs to be added thereto. The automatic chemical reservoir 40 could also comprise a solenoid operated piston to discharge a known quantity of chemical each discharge stroke of the piston. Other discharge systems may also be used.

It is pointed out that the skimmer S is adapted for receiving the conduit 52. Typically, a pool skimmer S is usually a circular cover having a hole in the middle thereof. Consequently, the automatic water controller of the present invention is adapted for being mounted quickly to the circular cover of the skimmer S. Therefore, the automatic liquid analyser and quality controller of the present invention may quickly be removed, thus making it portable. Also, the chemical reservoir 40 may be provided with a cover already mounted to the conduit 52, in which case the cover on the skinner S may simply be removed in order to make place for the chemical reservoir 40.

Although the above description refers to the analysis of chlorine, it is also possible to measure the pH in a water reservoir and adjust it. It is of course understood that the automatic liquid analyser and quality controller of the present invention is not to be limited to swimming pool water analysis. The automatic liquid analyser and quality controller can be integrated in a liquid treatment system of a fish hatchery, a food washing liquid, and the like, to automatically add disinfectant products and stabilizers other than chlorine. The liquid analysed could be potable water in a water treatment reservoir and the function of the automatic liquid analyser and quality controller could be to prevent waste in chemical additives to a fluid mixture. The liquid could also be a soft drink or all sorts of bottled liquids where the present invention may be useful in controlling some chemical of its composition.

It is within the ambit of the present invention to cover any obvious modifications of the embodiments described herein, provided such modifications fall within the scope of the appended claims.

1. A method for automatically calculating levels of a given chemical in a liquid from a liquid reservoir using colorimetry testing, comprising the steps of:
(i) collecting in an optical chamber a sample of liquid from a liquid reservoir;
(ii) taking a calibration colorimetry reading of said liquid sample, whereby a reference voltage value representative of an acceptable limit of a known chemical is calculated and stored in a memory of a controller unit;
(iii) releasing said liquid sample from said optical chamber;
(iv) collecting in the optical chamber a further sample of liquid from said liquid reservoir;
(v) adding a predetermined quantity of a reagent to said further sample in said chamber, said reagent chosen as having properties making it react to the presence of the known chemical present or to be added to said liquid; and
(vi) taking a test colorimetry reading of said further sample with said reagent added thereto and obtaining a voltage signal representative thereof, whereby a level of said known chemical in said liquid is known with respect to said reference voltage value.

2. The method according to claim 1, wherein step (iii) further comprises rinsing said optical chamber so as to prepare same for receiving said further sample.

3. The method according to claim 1, wherein the liquid reservoir is a swimming pool, the liquid is water and the known chemical is chlorine.

4. A chemical level calculator computer program product comprising code means recorded in a computer readable memory for executing the method defined in claim 1.

5. A method for automatically calculating and controlling levels of a given chemical in a liquid from a liquid reservoir using colorimetry testing, said method comprising the steps of:
(i) collecting in an optical chamber a sample of liquid from a liquid reservoir;
(ii) taking a calibration colorimetry reading of said liquid sample, whereby a reference voltage value representative of an acceptable limit of a known chemical is calculated and stored in a memory of a controller unit;
(iii) releasing said liquid sample from said optical chamber;
(iv) collecting in the optical chamber a further sample of liquid from said liquid reservoir;
(v) adding a predetermined quantity of a reagent to said further sample in said optical chamber, said reagent chosen as having properties making it react to the presence of the known chemical present or to be added to said liquid;
(vi) taking a test colorimetry reading of said further sample with said reagent added thereto and obtaining a voltage signal representative thereof, whereby a level of said known chemical is known with respect to said reference voltage value; and
(vii) adding a calculated quantity of said known chemical to said liquid reservoir in response to the calculated level of said known chemical in said further sample if the calculated level is below said reference voltage value.

6. The method according to claim 5, wherein step (vii) includes not adding said known chemical if the calculated level thereof is above said reference voltage value.

7. The method according to claim 6, wherein the steps (i) to (vii) are repeated until the calculated level of said known chemical is above said reference voltage value.

8. The method according to claim 7, wherein step (vii) further includes actuating an alarm if a certain amount of test colorimetry readings are successively below said reference voltage value.

9. The method according to claim 5, wherein step (iii) further comprises rinsing said optical chamber so as to prepare same for receiving said further sample.

10. The method according to claim 5, wherein the liquid reservoir is a swimming pool, the liquid is water and the known chemical is chlorine.

11. A chemical level calculator computer program product comprising code means recorded in a computer readable memory for executing the method defined in claim 5.

12. An automatic liquid analyser for calculating levels of a given chemical in a liquid from a liquid reservoir using colorimetry testing, said automatic liquid analyser comprising:
an optical chamber for receiving liquid samples therein, said optical chamber being connected to a liquid reservoir by a liquid inlet line, and being connected to a drain by a sample outlet line;
a first pumping device being mounted on said liquid inlet line and adapted for conveying samples of liquid from said liquid reservoir to said optical chamber;
a valve being mounted on said sample outlet line for opening and closing same so as to release and retain liquid in said optical chamber;
at least a first reagent reservoir for storing a reagent;
a reagent line extending between said reagent reservoir and said optical chamber;
at least a second pumping device being mounted on said reagent line and adapted for conveying predetermined quantities of said reagent from said reagent reservoir to said optical chamber;
a light source mounted to said optical chamber for emitting a light signal for colorimetry testing;
a light detector mounted to said optical chamber opposite said light source and aligned therewith for receiving said light signal for colorimetry testing; and
a controller unit for calculating the level of a known chemical according to intensity of said light signal detected and for controlling said automatic liquid analyser according to the method defined in claim 1, said controller unit having a display screen to indicate the level of the known chemical.

13. The apparatus according to claim 12, wherein said optical chamber is comprised of opaque walls so as to isolate liquid contained therein from external light.

14. The apparatus according to claim 12, wherein the liquid reservoir is a swimming pool, the liquid is water and the known chemical is chlorine.

15. The apparatus according to claim 14, wherein the reagent is orthotolidine.

16. An automatic liquid analyser and quality controller for controlling levels of a given chemical in a liquid from a liquid reservoir using colorimetry testing, said automatic liquid analyser and quality controller comprising:
an optical chamber for receiving liquid samples therein, said optical chamber being connected to a liquid reservoir by a liquid inlet line, and being connected to a drain by a sample outlet line;
a first pumping device being mounted on said liquid inlet line and adapted for conveying samples of liquid from said liquid reservoir to said optical chamber;
a valve being mounted on said sample outlet line for opening and closing same so as to release and retain liquid in said optical chamber;
at least a first reagent reservoir for storing a reagent;
a reagent line extending between said reagent reservoir and said optical chamber;
at least a second pumping device being mounted on said reagent line and adapted for conveying predetermined quantities of said reagent from said reagent reservoir to said optical chamber;
a light source mounted to said optical chamber for emitting a light signal for colorimetry testing;
a light detector mounted to said optical chamber opposite said light source and aligned therewith for receiving said light signal for colorimetry testing;
a chemical reservoir for storing an amount of a known chemical, said chemical reservoir being adapted to be mounted to a portion of said liquid reservoir, and having conveying means extending therefrom to the portion of said liquid reservoir and being actuated by a motor for adding calculated quantities of said known chemical to said liquid reservoir; and
a controller unit for calculating the level of said known chemical according to intensity of said light signal detected and for controlling said automatic liquid analyser and quality controller according to the method defined in claim 5.

17. The apparatus according to claim 16, wherein said optical chamber is comprised of opaque walls so as to isolate liquid contained therein from external light.

18. The apparatus according to claim 16, wherein the liquid reservoir is a swimming pool, the liquid is water and the known chemical is one of chlorine and bromine.

19. The apparatus according to claim 18, wherein the reagent is orthotolidine.

20. The apparatus according to claim 16, wherein said conveying means comprise an endless screw axially disposed in a cylindrical container.
